(19) United States
(12) Patent Application Publication
(10) Pub. No.: US 2017/0083834 A1
(43) Pub. Date: Mar. 23, 2017

(54) TICKETING OPERATIONS

(71) Applicant: AUTORITAT DEL TRANSPORT METROPOLITÀ, BARCELONA (ES)

(72) Inventors: Maria Del Carmen FÁBREGAS CASAS, BARCELONA (ES); Jordi TIRADO MORAGA, CORNELLÀ DE LLOBREGAT (ES); Daniel FERNÁNDEZ CASANELLAS, CORNELLÀ DE LLOBREGAT (ES)

(21) Appl. No.: 15/311,831

(22) PCT Filed: May 29, 2014
(86) PCT No.: PCT/EP2014/061213

§ 371 Date: Nov. 16, 2016

(51) Int. Cl. G06Q 10/02; H04L 9/32; H04L 29/06

(52) U.S. Cl. CPC G06Q 10/02; H04L 63/0823; H04L 9/3247; H04L 63/0807

(57) ABSTRACT

A generating system is provided for generating an executable code for a set of ticketing terminals, which have a common hardware configuration, to perform one or more ticketing operations by executing the executable code. The generating system comprises a first module, a second module and a third module. The first module is configured to receive a hardware independent code implementing the one or more ticketing operations. The second module is configured to generate the executable code, which is dependent on the hardware configuration, by processing at least the hardware independent code. The third module is configured to send the executable code to the set of ticketing terminals for them to perform the one or more ticketing operations by executing the executable code. A producing system is also provided for producing the hardware independent code. A distributing system is also provided comprising one producing system and a plurality of generating systems.

The present disclosure relates to systems and methods for generating an executable code for a set of ticketing terminals, which have a common hardware configuration, to perform one or more ticketing operations by executing the executable code.

The present disclosure further relates to systems for producing a hardware independent code implementing one or more ticketing operations, such that the above generating systems and methods can generate the executable code from said hardware independent code.

### BACKGROUND

A ticketing operation may be defined as an operation or transaction aimed at (potentially) enabling a user to access a service which is normally subjected to some kind of payment or compensation. A typical example may be transport ticketing in which a plurality of users may interact with ticketing terminals for gaining access to a (e.g. public) transport medium, such as a bus, a train, or any other transport medium.

In the case of transport ticketing, for example, different types of terminals may be suitably placed and configured to carry out different ticketing operations, such as e.g. recharging of a transport card, validation for gaining access for one or more trips, etc.

A ticketing operation may comprise a corresponding request from a user device (e.g. a smart card or a mobile phone) to the terminal for requesting such a type of operation, one or more accesses by the terminal to the user device to check that necessary conditions are satisfied, a payment transaction, updating of one or more fields in the user device (e.g. a field containing the number of available trips), etc.

A ticketing operation may therefore be conceptually defined in the form of a logic based on a sequence of instructions, rules or steps to be executed by the ticketing terminals. In order to make this conceptual definition or implementation executable by the ticketing terminals, different transformations of it may be required. For example: codification in a certain programming language, corresponding compilation, linkage with other codes, etc.

As commented above, a ticketing terminal may perform a ticketing operation by interacting with a user who may employ a user device for carrying out said interaction at the user side. The use of the user device may add a certain complexity to the conceptual definition/implementation of the ticketing rules and the subsequent transformations of it for obtaining the corresponding executable code.

This complexity of the subsequent transformations of the conceptual implementation of the ticketing operations may depend on the particular technology (i.e. type and/or hardware configuration) chosen for the ticketing terminals and user devices.

Other variables, different from those related to the type/configuration of the terminals and/or user devices, may also condition the logic (i.e. instructions, rules, steps) to be performed for carrying out the ticketing operations. That is, different (sequences of) steps may be carried out depending on these other variables.

Examples of such other variables may be the user's age (e.g. special prices may be defined for young and/or old people), the type of transport medium (e.g. different prices may be defined for different transport mediums), the requested route (e.g. different prices may be defined depending on the length of the route), etc.

For example, in some special cases, “privileged” people, e.g. at least some pensioners, may be liberated from paying for gaining access to public transportation. In these particular situations, payment for obtaining the right of accessing to the service may not be required. Instead, such people may own some kind of accreditation, for example pensioner accreditation, implemented in their user device indicating that payment is not required. Different kinds of discounts may also be possible.

The logic or conceptual steps implementing the ticketing operations of a ticketing system may therefore be relatively complex as a consequence of the above mentioned aspects: particular technology of the terminals and user devices, other variables such as e.g. user's age, type of transport medium, requested route, etc.

It is known that the conceptual definition/implementation of the ticketing operations for a particular ticketing system may be defined in natural language and written on a suitable support, such as paper, digital file, email, etc. This support containing the conceptual definition/implementation (of the ticketing operations) may then be provided to corresponding people for them to transform said conceptual definition into a form executable by the particular terminals/user devices of the ticketing system.

A drawback of such a way of communicating/distributing a rather complex conceptual implementation of ticketing operations (written in normal language) may be that it may be ambiguously interpreted by the technician(s) responsible for generating the corresponding executable code. Therefore, an executable code may result which may not be (completely) consistent with the conceptual definition/implementation, i.e. the executable code may result erroneous.

In addition, this “manual” process of implanting new ticketing operations or adapting existing ticketing operations may cause a certain delay between the conceptual (re)definition and the (re)generation of the corresponding executable code(s). In some situations, such as when a fraud is detected, significant losses may occur if updating of the affected functionalities is excessively delayed in time.

Moreover, known ticketing systems and methods are typically restricted to a particular hardware type/configuration common to all the terminals and user devices of the ticketing system. This feature may cause the overall ticketing system to be excessively dependent on the particular hardware type/configuration chosen, which may limit its evolution.

### SUMMARY

The present disclosure provides systems and methods solving at least some of the abovementioned problems.

In a first aspect, a generating system is provided for generating an executable code for a set of ticketing terminals, which have a common hardware configuration, to perform one or more ticketing operations by executing the executable code. The generating system comprises a first module, a second module and a third module.

The first module is configured to receive a hardware independent code implementing the one or more ticketing operations. The second module is coupled to the first module and is configured to generate the executable code by processing at least the hardware independent code, the executable code being dependent on the common hardware configuration. The third module is coupled to the second module and is configured to send the executable code to the set of ticketing terminals for them to perform the one or more ticketing operations by executing the executable code.

In the context of the present disclosure, a module may be defined as a combination of hardware and/or software elements configured to operate together for providing one or more desired functionalities. In this sense, a module may be also seen as comprising one or more sub-modules which may work together for the module to provide the required functionality or functionalities.

According to this definition of the term module, the proposed generating system may be seen as a single module having three sub-modules: a first one for receiving the hardware independent code, a second one for generating the executable code from the hardware independent code, and a third one for sending the executable code to the terminals.

The hardware independent code may be an intermediate code between a source code conceptually implementing the ticketing operations and the executable code to be executed by the ticketing terminals. This hardware independent code may have been generated by a suitable producing system comprising a tool similar to a compiler for generating, from the source code, a code similar to an object code.

Details about such a producing system will be provided in other parts of the description.

This object code may be a binary code in which aspects that depend on the hardware type/configuration of the ticketing terminals (where the executable code is to be run) are not still resolved. This object code may therefore be defined as an “almost” executable code with aspects dependent on the hardware type/configuration unresolved.

The second module of the generating system may comprise a tool similar to a linker having as output the executable code. This linker (or similar tool) may generate the executable code from one or more suitable inputs. A first input may be the hardware independent code (or object code). A second input may be other pieces of software dependent on the hardware type/configuration of the ticketing terminals. These other pieces of software may also be called static software modules. The term “static” is used herein to indicate that said modules are used at “linkage” time.

This linker (or similar tool) may thus operate in such a way that hardware dependent aspects are resolved in the hardware independent code (or object code), said resolution (of hardware dependent aspects) causing generation of the executable code. In this sense, the linker (or similar tool) may be seen as an incorporator of hardware dependent aspects to the hardware independent code, such that the executable code is finally generated with hardware dependent aspects resolved.

For example, I/O (Input/Output) operations may depend on the particular type/configuration of the ticketing terminal where the executable code is to be run. This I/O issues may therefore be resolved by the second module of the generating system by processing the hardware independent code and e.g. a software library implementing how I/O operations have to be specifically performed in the ticketing terminal.

An aspect of the proposed generating system may thus be that ambiguous interpretations by a human being of a given conceptual implementation of the ticketing operations may be avoided.

Another aspect of the proposed generating system may be that a same conceptual implementation of ticketing terminals may be performed in different types of terminals having different hardware configurations. For example, in a ticketing system having different types/configurations of ticketing terminals, a different generating system may be used for generating a different executable code for each of said different types/configurations of ticketing terminals.

Very versatile ticketing systems may therefore be formed, such that heterogeneous types/configurations of ticketing terminals may co-exist in a same ticketing system. This may also permit integrating very easily different existing networks of ticketing terminals having different hardware types/configurations.

A further aspect may be that, with the proposed system, the prior art transformation by technical staff of the conceptual implementation of the ticketing rules for obtaining the executable code may be avoided in this case. A new executable code or a new version of an existing executable code may thus be generated in a shorter time in comparison with prior art systems/methods.

In some examples, the generating system may further comprise the set of ticketing terminals.

In examples of the generating system, the third module and the set of ticketing terminals may be connected through a communications network, such that the executable code may be sent (from the third module to the terminals) through said communications network.

This communications network may be e.g. the Internet or other known type of public or private network. Depending on the circumstances, the executable code may be sent to the terminals by using secure protocols in said communications network for improving security of the system. The risk of suffering attacks/frauds may thus be reduced.

According to examples, the generating system may further comprise at least one static software module which may be dependent on the common hardware configuration of the ticketing terminals. Moreover, the second module may be configured to generate the executable code by further processing the at least one static software module.

As commented above, these static software modules may be defined as hardware dependent pieces of software which are used for resolving hardware dependent aspects in the hardware independent code for generating the executable code. The term “static” is used herein in the sense that these static modules are used at “linkage” time in contrast to “execution” time.

Alternatively or additionally to having static modules, each of the ticketing terminals may comprise at least one dynamic software module which may be dependent on the common hardware configuration of the ticketing terminals, such that the executable code may be generated to cause execution of said at least one dynamic software module.

The term “dynamic” is used herein in the sense that said dynamic software modules are used at “execution” time in contrast to “linkage” time. In this case, the executable code may therefore be generated in such a way that it may call to said “dynamic software modules” for resolving hardware dependent aspects at execution time.

For example, the ticketing terminals may have stored in its memory executable (sub) routines (i.e. dynamic software modules) for carrying out I/O operations depending on the particular hardware configuration of the ticketing terminals, and the executable code may be generated in such a way that it may cause execution of said dynamic modules when required.

In some implementations of the generating system, modules of both types (static and dynamic software modules) may be used for making the executable code to be runnable by the ticketing terminals.

In some implementations of the generating system, the one or more ticketing operations may be transport ticketing operations which may comprise one or more of the following types of transport ticketing operations: buying a transport ticket, recharging a transport ticket, validating a transport ticket. However, one skilled in the art may appreciate that other known ticketing operations may be comprised in the transport ticketing operations.

In a second aspect, a producing system is provided for producing a hardware independent code implementing one or more ticketing operations. The producing system comprises a fourth module, a fifth module and a sixth module.

The fourth module is configured to receive a source code conceptually implementing the one or more ticketing operations. This source code may be written in a formal language which may define unambiguously the corresponding ticketing operations. This formal language may be based on a known programming language or a combination of known programming languages. Alternatively, this formal language may be a domain-specific language.

A domain-specific language (DSL) is a computer language specialized to a particular application domain. This is in contrast to a general-purpose language (GPL), which is broadly applicable across domains, and lacks specialized features for a particular domain.

The fifth module is coupled to the fourth module and is configured to produce the hardware independent code by processing at least the source code. This fifth module may comprise a tool similar to a compiler for generating, from the received source code, a code similar to an object code. This object code may be a binary code in which aspects that depend on the hardware type/configuration of the ticketing terminals (where the executable code is to be run) are not still resolved.

The sixth module is coupled to the fifth module and is configured to send the hardware independent code to at least one generating system as the ones previously described. This sixth module may therefore send the obtained hardware independent code to one or more of the previously described generating systems for generating corresponding executable code(s). A diversity of different types/configurations of ticketing terminals may thus perform a same conceptual definition of ticketing rules when a different generating system is used for each different type/configuration of ticketing terminals.

A distributing system may also be provided for distributing an implementation of one or more ticketing operations among a plurality of sets of ticketing terminals, for said ticketing terminals to perform the one or more ticketing operations. Each of said sets may have a common hardware configuration, i.e. all the terminals of a same set may belong to a same hardware type/configuration.

Taking this into account, the distributing system may comprise a producing system as the ones described before, for producing one or more hardware independent codes implementing the one or more ticketing operations. The distributing system may further comprise one or more generating systems as the ones described above for each of the sets of ticketing terminals. Each of the generating systems may be configured to receive the hardware independent codes, respectively, from the producing system in order to generate, from the hardware independent code, an executable code for the ticketing terminals of the corresponding set to perform the one or more ticketing operations by executing the executable code.

With this proposed combination of a producing system (as the ones described before) and a plurality of generating systems (as the ones described before), a versatile, efficient and multiplatform distributing system is provided.

The term “versatile” is used herein to indicate that this distributing system may permit forming different topologies of networks of ticketing terminals relatively easily.

The term “efficient” is used herein in the sense that new ticketing operations or modifications of existing ticketing operations may be implanted in a relatively short time.

The term “multiplatform” is used herein in the sense that ticketing terminals of different hardware types/configurations may co-exist in the same network of ticketing terminals in such a way that they can execute ticketing operations based on a common conceptual definition/implementation of ticketing operations.

In a third aspect, a method is provided to be performed in a generating system as the ones described before to generate an executable code for a set of ticketing terminals, which have a common hardware configuration, to perform one or more ticketing operations by executing the executable code.

The method comprises receiving a hardware independent code implementing the one or more ticketing operations at the first module (of the generating system). The method further comprises generating the executable code at the second module (of the generating system) by processing at least the hardware independent code, the executable code being dependent on the common hardware configuration. The method still further comprises sending from the third module (of the generating system) the executable code to the set of ticketing terminals for them to perform the one or more ticketing operations by executing the executable code.

The aspects (advantages and principles) mentioned with respect to the previously described generating systems can also be attributed to this method of generating an executable code.

A method is also provided to be performed in a distributing system as the ones described before to distribute an implementation of one or more ticketing operations among a plurality of sets of ticketing terminals for said ticketing terminals to perform the one or more ticketing operations, each of said sets of ticketing terminals having a common hardware configuration.

The distributing method may comprise receiving at the fourth module of the producing system (of the distributing system) a source code conceptually implementing the one or more ticketing operations. The distributing method may further comprise producing a hardware independent code at the fifth module of the producing system (of the distributing system) by processing at least the source code. The distributing method may still further comprise sending from the sixth module of the producing system (of the distributing system) the hardware independent code to each of the generating systems of the distributing system. The distributing method may also comprise performing a generating method as the ones described before at each of the generating systems (of the distributing system) for generating, from the hardware independent code, an executable code for the ticketing terminals of the corresponding set to perform the one or more ticketing operations by executing the executable code.

The aspects (advantages and principles) mentioned with respect to the previously described distributing systems can also be attributed to this method of distributing an implementation of ticketing operations.

In a fourth aspect, a computer program product is provided comprising program instructions for causing a computer to perform any of the methods previously described. This disclosure also relates to such a computer program product embodied on a storage medium (for example, a CD-ROM, a DVD, a USB drive, on a computer memory or on a read-only memory) or carried on a carrier signal (for example, on an electrical or optical carrier signal).

The program may be in the form of source code, object code, a code intermediate source and object code such as in partially compiled form, or in any other form suitable for use in the implementation of the processes according to the present disclosure. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

### BRIEF DESCRIPTION OF THE DRAWINGS

Non-limiting examples of the present disclosure will be described in the following, with reference to the appended drawings, in which:

FIG. 1 is a block diagram representing a producing system according to a first example;

FIG. 2 is a block diagram representing a producing system according to a second example;

FIG. 3 is a block diagram representing a generating system according to a third example; and

FIG. 4 is a block diagram representing a distributing system according to a fourth example.

### DETAILED DESCRIPTION OF EXAMPLES

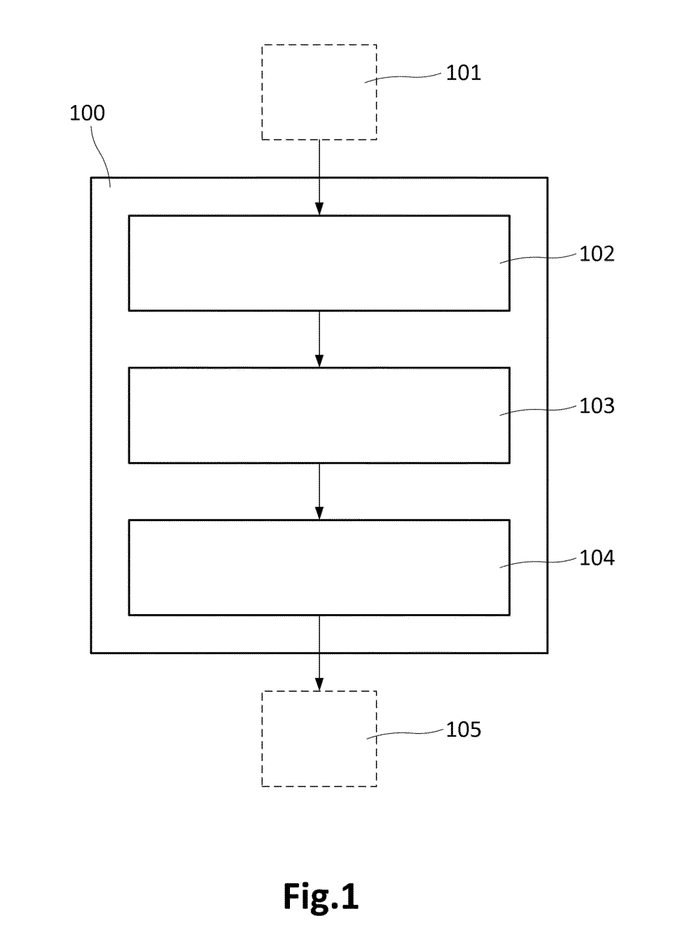

FIG. 1 is a block diagram representing a producing system 100 for producing a hardware independent code 105 implementing one or more ticketing operations, according to a first example. In this particular example, the producing system 100 is shown comprising a receiving module 102, a producing module 103, and a sending module 104.

The receiving module 102 may be configured to receive a source code 101 conceptually implementing the one or more ticketing operations. This source code 101 may be written in a formal language unambiguously describing the implementation of the one or more ticketing operations. This formal language may be based on e.g. a known programming language such as e.g. Java, C, etc. or a combination of (at least some) of them. Alternatively, this formal language may be a domain-specific language.

The producing module 103 may be configured to produce the hardware independent code 105 by processing at least the received source code 101.

The sending module 104 may be configured to send the produced hardware independent code 105 to one or more generating systems, examples of which will be described with reference to other Figures.

In alternative representations, the producing system may be understood as comprising a single module 100 having a receiving sub-module 102, a producing sub-module 103, and a sending sub-module 104.

In other configurations, other combinations in terms of modules and sub-modules may also be possible. For example, a single module or sub-module may provide several functionalities of among those previously described as provided by the receiving module 102, the producing module 103, and the sending module 104 of FIG. 1.

The producing system or module 100 may comprise a processor and a memory (not shown in FIG. 1). The memory may have stored therein one or more computer programs whose execution may cause the processor to perform a method of producing the hardware independent code 105.

In some examples, these one or more computer programs may be just a single program comprising a receiving (sub) routine 102, a producing (sub) routine 103 and a sending (sub) routine 104. Alternatively, the one or more computer programs may comprise a receiving program 102, a producing program 103, and a sending program 104. These (sub) routines and programs 102-104 may be configured to perform the functionalities that have been described before in terms of the modules or sub-modules 102-104, respectively.

In alternative implementations, each of the modules or sub-modules 102-104 may comprise its own processor and memory, and each memory may comprise a corresponding computer program for causing its related processor to provide the functionalities that have been described before in terms of the modules or sub-modules 102-104, respectively.

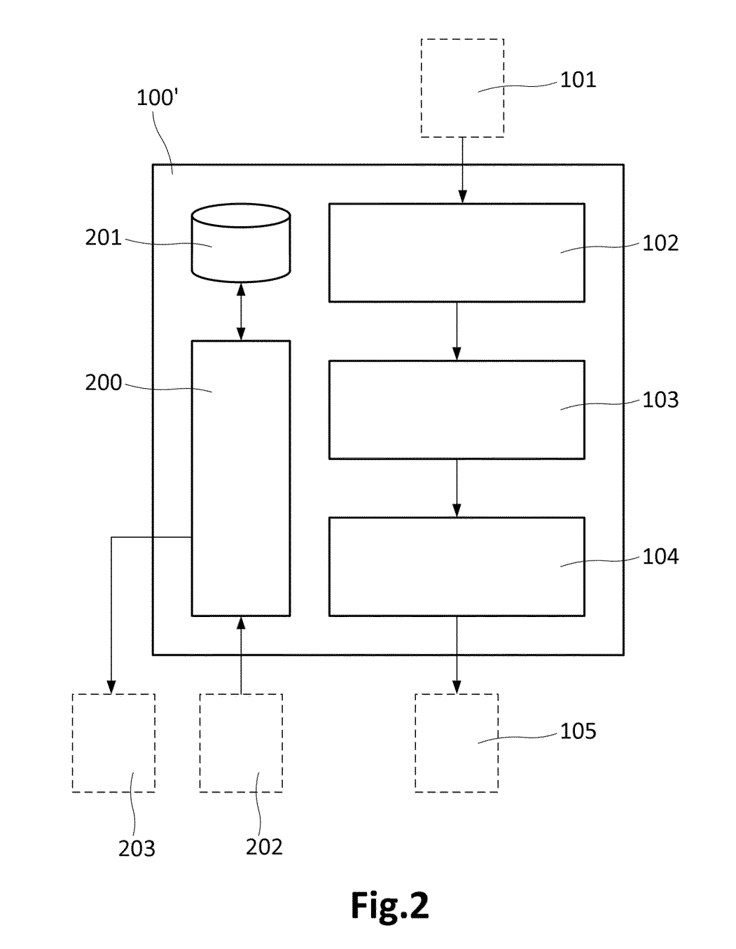

FIG. 2 is a block diagram representing another producing system according to a second example. This other producing system 100′ is similar to the one shown in FIG. 1. Reference numbers from FIG. 1 have been reused for indicating the same or similar elements.

One difference with respect to the system of FIG. 1 may be that the producing system 100′ of FIG. 2 may further comprise a certifying module 200. This certifying module 200 may be configured to certify executable codes 202 from one or more generating systems, examples of which will be described with reference to other Figures. The certifying module 200 may be further configured to return the certified executable modules 203 to the corresponding generating system(s).

In some examples, this certifying module 200 may be comprised in the producing system 100′, as shown in the particular case of FIG. 2. In other examples, the certifying module 200 may be external to the producing module 100′, in which case a suitable interchange of certification data may exist between said external/remote certifying module 200 and the producing system 100′.

In some examples, an executable code 202 may be certified e.g. as a result of its validation by technical personnel. This may permit e.g. a relatively strict control of generated executable codes over an entire ticketing network. This control may be based on e.g. permitting only execution of executable codes that have been certified.

The certification performed by the certifying module 200 may comprise at least partially signing the executable code 202. This signature may comprise a time stamp or similar data in such a way that the executable codes 202 may be controlled according to diverse time criteria. For example, only the executable code with the most recent time stamp may be selected for its execution. This way, erroneous executions of old versions may be suitably avoided.

The certifying module 200 may be further configured to at least partially encrypt the executable code 202. This way, security of the system may be better ensured if e.g. an executable code is intercepted by an attacker for committing a fraud. Once intercepted, as the executable code is (at least partially) encrypted, it may be relatively difficult for the attacker to analyse the executable code and infer from it how the ticketing operations are implemented.

The certifying module 200 may be also configured to store each of the certified executable codes 203 in a repository 201 of certified executable codes. With such a feature, a full history of certified executable codes may be available for e.g. competent technicians to perform software audits or similar tasks.

This repository 201 may be comprised in the producing system 100′, as it is shown in FIG. 2. In alternative implementations, the repository of certified executable codes 201 may be external to the producing system 100′, i.e. the repository 201 may be arranged in a remote location. In this case, a suitable communication may be needed between the certifying module 200 and the external/remote repository 201 for them to suitably interchange certification data, such as e.g. the certified executable codes.

Having the certifying module 200 in a producing system 100′ may permit performing a centralised control of the generated executable codes. Hence, all the certified executable codes that have been distributed over a ticketing/network system may be under strict control or supervision of a single/central technical team.

In any of the examples of producing systems 100, 100′ described with reference to FIGS. 1 and 2, the producing module or sub-module or (sub) routine 103 may comprise a tool, which may be software and/or hardware implemented, similar to a compiler. This compiler 103 may be configured to transform the source code 101 (conceptually implementing the one or more ticketing operations) into e.g. a binary code, which may be similar to an object code, with hardware dependent issues unresolved.

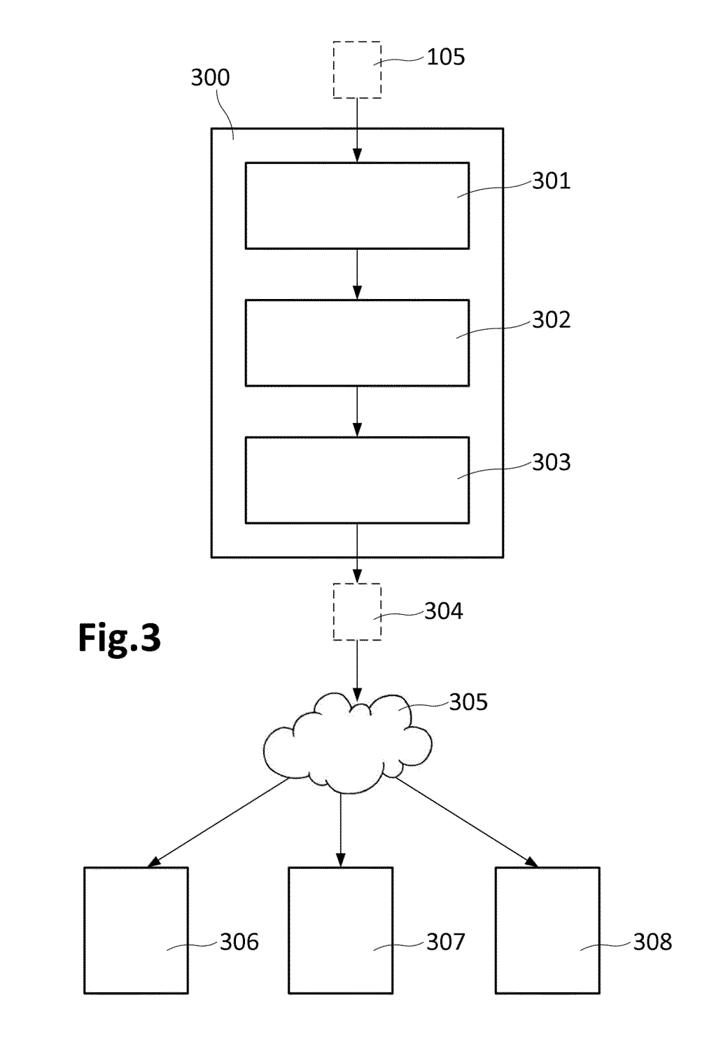

FIG. 3 is a block diagram representing a generating system 300 according to a third example. This generating system 300 is shown comprising a receiving module 301, a generating module 302, and a sending module 303. FIG. 3 further shows a set of ticketing terminals 306-308 having a common hardware configuration. These terminals 306-308 may also be comprised in the generating system 300 or may be external to the generating system 300.

The receiving module 301 may be configured to receive a hardware independent code 105 implementing one or more ticketing operations. This hardware independent code 105 may be produced by a producing system such as any of the producing systems previously described with reference to FIGS. 1 and 2.

The generating module 302 may be configured to generate the executable code 304 by processing at least the hardware independent code 105, said executable code 304 being dependent on the common hardware configuration of the ticketing terminals 306-308.

The sending module 303 may be configured to send the generated executable code 304 to the set of ticketing terminals 306-308 for them to perform the one or more ticketing operations by executing the executable code 304.

The sending module 303 and the set of ticketing terminals 306-308 may be connected through a communications network 305, such as e.g. the Internet or any other known type of communications network. This way, the generated executable code 304 may be sent by the sending module 303 through said communications network to the ticketing terminals 306-308.

The generating system or module 300 may comprise a processor and a memory (not shown in FIG. 3). The memory may have stored therein one or more computer programs whose execution may cause the processor to perform a method of generating the executable code 304.

In some examples, these one or more computer programs may be just a single program comprising a receiving (sub) routine 301, a generating (sub) routine 302 and a sending (sub) routine 303. Alternatively, the one or more computer programs may comprise a receiving program 301, a producing program 302, and a sending program 303. These (sub) routines and programs 301-303 may be configured to perform the functionalities that have been described before as provided by the modules or sub-modules 301-303, respectively.

In alternative implementations, each of the modules or sub-modules 301-303 may comprise its own processor and memory, and each memory may comprise a corresponding computer program for causing its related processor to provide the functionalities that have been described before as provided by the modules or sub-modules 301-303, respectively.

According to examples, the generating module or sub-module or (sub) routine 302 may comprise a tool similar to a linker (not shown). The linker (or similar tool) may have as input the hardware independent code 105 which may have hardware dependent aspects (of the terminals 306-308) unresolved. The linker may also have as input one or more static software modules having the necessary (hardware dependent) code for resolving the hardware dependent aspects that are unresolved in the hardware independent code 105.

The linker may thus generate the corresponding executable code 304 by adding the necessary code from the static software module(s) to the hardware independent code 105 for resolving the unresolved hardware dependent issues in the hardware independent code 105. Therefore, once processed by the linker (or similar tool), the generated executable code 304 may be executable in the hardware type/configuration of the ticketing terminals 306-308.

In some implementations, the generating system 300 may further comprise a module (not shown) configured to send its generated executable code 304 to a producing system such as the ones described in relation to FIG. 2. The generating system 300 may further comprise a module (not shown) configured to receive, from the producing system, the executable code which has been certified by the producing system.

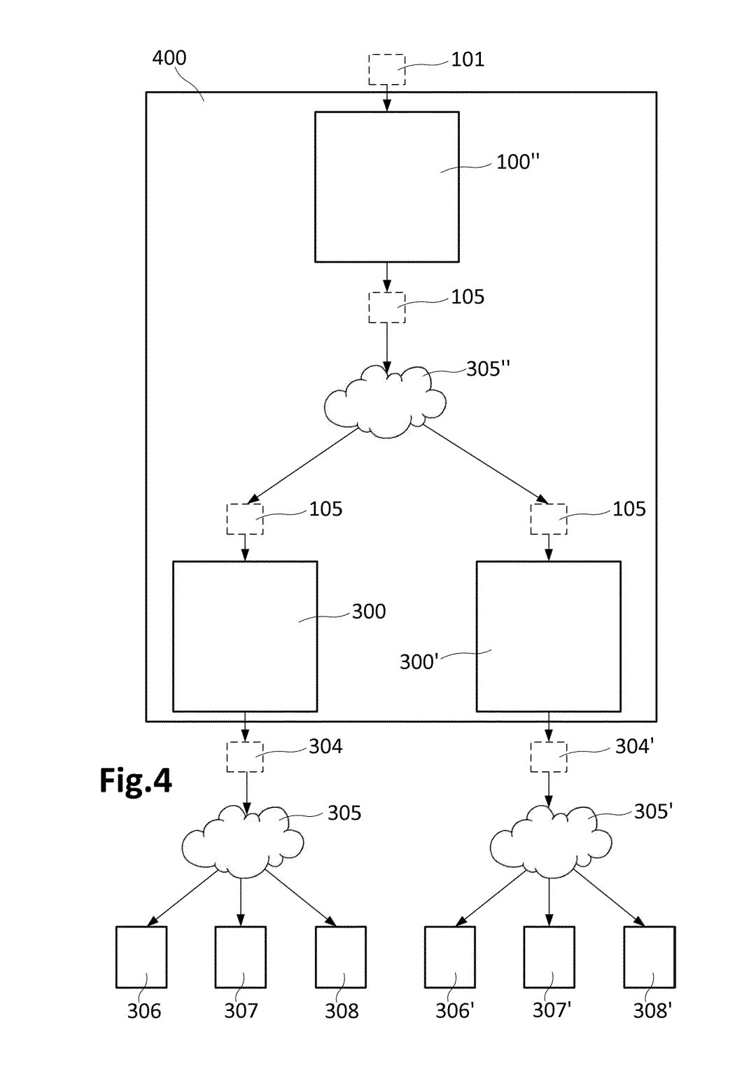

FIG. 4 is a block diagram representing a distributing system 400 according to a further example. The distributing system 400 is shown comprising one producing system 100″ as the ones previously described with reference to FIGS. 1 and 2, and two generating systems 300, 300′ as the ones previously described with reference to FIG. 3.

The producing system 100″ may therefore be configured to receive a source code 101 conceptually implementing one or more ticketing operations, to obtain a corresponding hardware independent code 105, and to send said hardware independent code 105 to the generating systems 300, 300′.

The producing system 100″ and the generating systems 300, 300′ may be interconnected through a suitable communications network 305″, such as e.g. the Internet. This way, the producing system 100″ may send the generated hardware independent code 105 to the generating systems 300-300′ through said communications network 305″.

Each of the generating systems 300, 300′ may be configured to receive from the producing system 100″ the hardware independent code 105, to generate a corresponding executable code 304, 304′ (from at least the hardware independent code 105), and to send the executable code 304, 304′ to the corresponding set of ticketing terminals 306-308, 306′-308′.

Each of the generating systems 300, 300′ may be interconnected with its related set of ticketing terminals 306-308, 306′-308′ through a corresponding communications network 305, 305′. This way, each generating system 300, 300′ may send its generated executable code 304, 304′ to its related set of ticketing terminals 306-308, 306′-308′ through the corresponding communications network 305, 305′.

In some examples, all the communication networks 305, 305′, 305″ may be the same network, such as e.g. the Internet, or, in alternative examples, at least some of them 305, 305′, 305″ may be different communication networks.

FIG. 4 shows each of the sets of ticketing terminals 306-308, 306′-308′ not comprised in the corresponding generating system 300, 300′. However, in alternative examples, some of said sets of ticketing terminals 306-308, 306′-308′ could be comprised in the corresponding generating system 300, 300′.

The terminals 306-308 may have a first hardware configuration, and the terminals 306′-308′ may have a second hardware configuration, said first and second hardware configurations being different from each other. The generating system 300 may be accordingly configured, such as e.g. having specific static software modules, for resolving hardware dependent issues of the first hardware configuration. Similarly, the generating system 300′ may be accordingly configured, such as e.g. having specific static software modules, for resolving hardware dependent issues of the second hardware configuration.

The distributing system 400 of FIG. 4 may therefore allow distributing a same implementation of ticketing operations over a network of heterogeneous terminals easily, without ambiguities and in a short time.

For the sake of simplicity, FIG. 4 shows only two generating systems 300, 300′ and corresponding sets of ticketing terminals 306-308, 306′-308′, each set of terminals having only three terminals in this particular case.

However, it will appreciated by any person skilled in the art that any number of generating systems and terminals per set of terminals may be easily integrated under the same producing system 100″.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A generating system for generating an executable code for a set of ticketing terminals to perform one or more ticketing operations by executing the executable code, the ticketing terminals having a common hardware configuration; the generating system comprising:
a first module configured to receive a hardware independent code implementing the one or more ticketing operations;
a second module, coupled to the first module, configured to generate the executable code by processing at least the hardware independent code, the executable code being dependent on the common hardware configuration; and
a third module, coupled to the second module, configured to send the executable code to the set of ticketing terminals for them to perform the one or more ticketing operations by executing the executable code.

2. A generating system according to claim 1, further comprising the set of ticketing terminals.

3. A generating system according to claim 2, wherein the third module and the set of ticketing terminals are connected through a communications network, such that the executable code is sent through the communications network.

4. A generating system according to claim 1, further comprising at least one static software module, wherein:
the at least one static software module is dependent on the common hardware configuration of the ticketing terminals; and
the second module is configured to generate the executable code by further processing the at least one static software module.

5. A generating system according to claim 1, wherein:
each of the ticketing terminals comprises at least one dynamic software module which is dependent on the common hardware configuration of the ticketing terminals; and
the executable code is generated to cause execution of the at least one dynamic software module.

6. A generating system according to claim 1, wherein the one or more ticketing operations are transport ticketing operations comprising one or more of the following types of transport ticketing operations: buying a transport ticket, recharging a transport ticket and validating a transport ticket.

7. (canceled)

8. A distributing system for distributing an implementation of one or more ticketing operations among a plurality of sets of ticketing terminals for the ticketing terminals to perform the one or more ticketing operations, each of the sets of ticketing terminals having a common hardware configuration;
the distributing system comprising:
a producing system for producing one or more hardware independent codes implementing the one or more ticketing operations; and
one or more generating systems, according to claim 1, for each of the sets of ticketing terminals, configured to receive the hardware independent codes, respectively, from the producing system for generating, from the hardware independent code, an executable code for the ticketing terminals of the respective set to perform the one or more ticketing operations by executing the executable code; wherein
the producing system comprises:
a fourth module configured to receive a source code conceptually implementing the one or more ticketing operations,
a fifth module, coupled to the fourth module, configured to produce the hardware independent code by processing at least the source code,
a sixth module, coupled to the fifth module, configured to send the hardware independent code to the one or more generating systems.

9. A distributing system according to claim 8, further comprising at least one certifying module configured to certify each of the generated executable codes.

10. A distributing system according to claim 9, wherein the at least one certifying module is configured to certify each of the executable codes by at least partially signing the executable code.

11. A distributing system according to claim 9, wherein the at least one certifying module is configured to store each of the certified executable codes in a repository of certified executable codes.

12. A distributing system according to claim 9, wherein the at least one certifying module is configured to at least partially encrypt each of the certified executable codes.

13. A distributing system according to claim 9, wherein:
the certifying module is comprised in the producing system;
each of the generating systems further comprises a first dispatch module configured to send its generated executable code to the producing system;
the producing system further comprises a first receiving module configured to receive from each of the generating systems the respective generated executable code;
the producing system further comprises a second dispatch module configured to send to each of the generating systems the respective certified executable code;
each of the generating systems further comprises a second receiving module configured to receive the respective certified executable code from the producing system.

14. A generating method performed in a generating system according to claim 1 for generating an executable code for a set of ticketing terminals to perform one or more ticketing operations by executing the executable code, the ticketing terminals having a common hardware configuration; the generating method comprising:
receiving a hardware independent code implementing the one or more ticketing operations at the first module of the generating system;
generating the executable code by processing at least the hardware independent code at the second module of the generating system, the executable code being dependent on the common hardware configuration;
sending from the third module of the generating system the executable code to the set of ticketing terminals for them to perform the one or more ticketing operations by executing the executable code.

15. A distributing method performed in a distributing system for distributing an implementation of one or more ticketing operations among a plurality of sets of ticketing terminals for the ticketing terminals to perform the one or more ticketing operations, each of the sets of ticketing terminals having a common hardware configuration; the distributing method comprising:
receiving at a fourth module of a producing system of the distributing system a source code conceptually implementing the one or more ticketing operations;
producing a hardware independent code at a fifth module of the producing system of the distributing system by processing at least the source code;
sending from a sixth module of the producing system of the distributing system the hardware independent code to each of the one or more generating systems of the distributing system;
performing a generating method according to claim 14 at each of the generating systems of the distributing system for generating, from the hardware independent code, an executable code for the ticketing terminals of the corresponding set to perform the one or more ticketing operations by executing the executable code.

16. A computer program product comprising program instructions for causing a computer to perform a method according to claim 14.

17. A computer program product according to claim 16, embodied on a storage medium.

18. (canceled)

19. A distributing system according to claim 10, wherein the at least one certifying module is configured to store each of the certified executable codes in a repository of certified executable codes.

20. A distributing system according to claim 10, wherein the at least one certifying module is configured to at least partially encrypt each of the certified executable codes.

21. A distributing system according to claim 11, wherein the at least one certifying module is configured to at least partially encrypt each of the certified executable codes.
